(19) United States
(12) Patent Application Publication
(10) Pub. No.: US 2017/0147264 A1
(43) Pub. Date: May 25, 2017

(54) IMAGE PROCESSING APPARATUS AND IMAGE PROCESSING METHOD

(71) Applicant: Renesas Electronics Corporation, Tokyo (JP)

(72) Inventors: Motoyasu Takabatake, Tokyo (JP); Hisashi Shiota, Tokyo (JP); Atsushi Nakamura, Tokyo (JP); Manabu Koike, Tokyo (JP)

(21) Appl. No.: 15/338,123

(22) Filed: Oct. 28, 2016

(30) Foreign Application Priority Data
Nov. 19, 2015 (JP) 2015-226846

(51) Int. Cl. G06F 3/06; G06F 12/0875; G06F 9/38

(52) U.S. Cl. CPC G06F 3/0659; G06F 3/0604; G06F 3/0683; G06F 9/3802; G06F 12/0875; G06F 2212/452

(57) ABSTRACT

An image processing apparatus includes: a first memory that stores image data; a second memory that can be accessed at a speed higher than that in an access to the first memory; a first operation unit that executes a predetermined task on a predetermined area of the image data transferred from the first memory to the second memory; a second operation unit that determines whether there is an overlapping part of a first area of the image data executed corresponding to a first task executed by the first operation unit and a second area of the image data executed corresponding to a second task different from the first task; and a memory control apparatus that controls the first memory and the second memory. The memory control apparatus performs control to reuse the image data in the second memory when it is determined that there is an overlapping part.

### CROSS-REFERENCE TO RELATED APPLICATIONS

This application is based upon and claims the benefit of priority from Japanese patent application No. 2015-226846, filed on Nov. 19, 2015, the disclosure of which is incorporated herein in its entirety by reference.

### BACKGROUND

The present invention relates to an image processing apparatus and an image processing method. For example, the present invention relates to an image processing apparatus and an image processing method for image processing in which image data accessed when one task is executed overlaps image data accessed when another task is executed.

Image recognition processing apparatuses for, for example, vehicles, need to process image data that is input in real time and recognize objects and the like. It is therefore required to process large pieces of image data at a high speed within a limited period of time. Most of the image recognition processing is performed, based on specific coordinates, using peripheral data of the coordinates. Further, it is possible to execute the same processing on different coordinates in parallel.

When a plurality of coordinates are separately processed and these coordinates are located close to one another, peripheral data accessed in the respective processes may overlap one another. The overlapped data in the respective processes on the plurality of coordinates may be shared, for example, on a cache and may be reused.

As techniques for improving the speed of data processing, Japanese Unexamined Patent Application Publication No. 2014-225088 and Japanese Unexamined Patent Application Publication No. 2002-318688 are, for example, known.

An apparatus disclosed in Japanese Unexamined Patent Application Publication No. 2014-225088 prepares, when a plurality of processors perform processing in parallel, necessary data by the time each of the processors uses the data. In this apparatus, an access instruction is sent to a memory controller from a task controller, and the task is executed after the data is transferred to a data storage unit in advance. After the task is completed, the data is transferred from the data storage unit to an external storage unit.

Japanese Unexamined Patent Application Publication No. 2002-318688 discloses a technique for preparing, when image processing is performed, a list of coordinates to be processed, predicting data to be used from the list of the coordinates and performing prefetch, to thereby reduce cache miss.

### SUMMARY

In the techniques disclosed in Japanese Unexamined Patent Application Publication No. 2014-225088 and Japanese Unexamined Patent Application Publication No. 2002-318688, reuse of the data transferred to a cache memory or the like is not considered. It is thus required to reuse reusable image data more definitely.

The other problems of the related art and the novel characteristics of the present invention will be made apparent from the descriptions of the specification and the accompanying drawings.

According to one embodiment, an image processing apparatus determines whether there is an overlapping part of a first area of image data executed corresponding to a first task and a second area of the image data executed corresponding to a second task, and performs control to reuse the image data on a memory when it is determined that there is an overlapping part.

According to the embodiment, it is possible to improve the speed of processing the image data.

### BRIEF DESCRIPTION OF THE DRAWINGS

The above and other aspects, advantages and features will be more apparent from the following description of certain embodiments taken in conjunction with the accompanying drawings, in which:

FIG. 1 is a schematic view showing a schematic configuration example of an image processing apparatus according to an embodiment;

FIG. 2 is a block diagram showing a configuration of an image processing system according to the embodiment;

FIG. 3 is a block diagram showing one example of a configuration of an image processing apparatus according to a first embodiment;

FIG. 4 is a flowchart showing one example of an operation of processing for adding instructions performed in compile processing in a compile apparatus;

FIG. 5 is a diagram showing one example of a source code compiled by the compile apparatus;

FIG. 6 is a schematic view showing one example of a first area of a first task and a second area of a second task;

FIG. 7 is a diagram showing one example of instructions added to an object code in Steps 101 to 103 shown in FIG. 4;

FIG. 8 is a diagram showing one example of a determination sentence that determines whether there is an overlapping part of the first area and the second area;

FIG. 9 is a diagram showing one example of the determination sentence that determines whether there is an overlapping part of the first area and the second area;

FIG. 10 is a diagram showing one example of instructions added to the object code in Steps 101 to 103 shown in FIG. 4;

FIG. 11 is a diagram showing one example of instructions added to the object code in Steps 104 and 105 shown in FIG. 4;

FIG. 12 is a sequence chart showing one example of an operation of the image processing apparatus according to the first embodiment;

FIG. 13 is a block diagram showing one example of a configuration of an image processing apparatus according to a second embodiment;

FIG. 14A is a schematic view showing one example of a first area of a first task and a second area of a second task;

FIG. 14B is a diagram showing a relative position of an overlapping area in the first area;

FIG. 14C is a diagram showing a relative position of an overlapping area in the second area;

FIG. 14D is a schematic view showing one example of a state of an address space of a local memory just after the second task is executed;

FIG. 14E is a schematic view showing one example of a state of the address space of the local memory after a storage position on the address space is corrected;

FIG. 14F is a schematic view for describing a copy of an overlapping area;

FIG. 15 is a flowchart showing one example of an operation of the image processing apparatus according to the second embodiment; and

FIG. 16 is a flowchart showing one example of an operation of the image processing apparatus when data on a local memory is reused by changing addresses.

### DETAILED DESCRIPTION

For the clarification of the description, the following description and the drawings may be omitted or simplified as appropriate. Throughout the drawings, the same components are denoted by the same reference symbols and overlapping descriptions will be omitted as appropriate.

### Outline of Embodiments

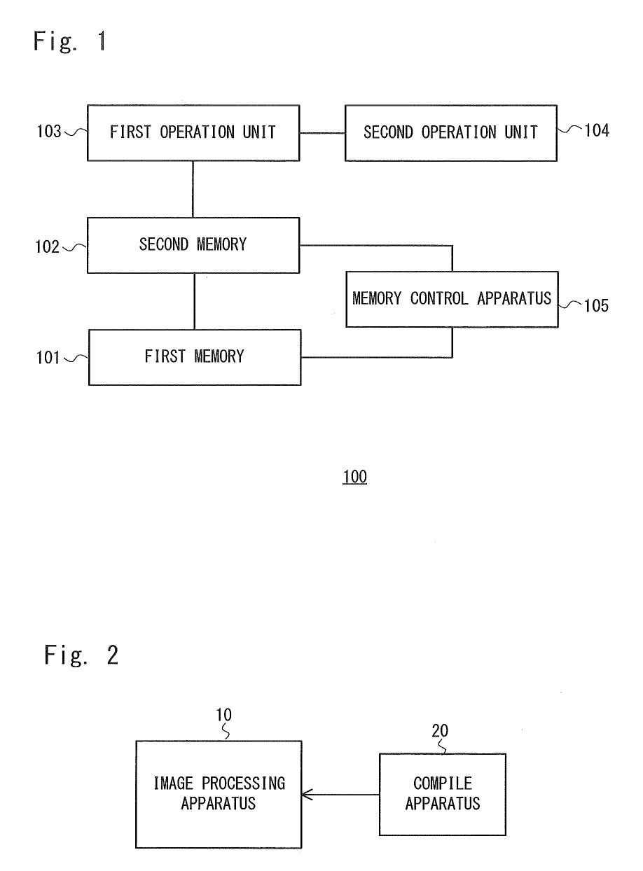

An outline of embodiments will be given below. FIG. 1 is a schematic view showing a schematic configuration example of an image processing apparatus 100 according to the embodiments. As shown in FIG. 1, the image processing apparatus 100 includes a first memory 101, a second memory 102, a first operation unit 103, a second operation unit 104, and a memory control apparatus 105. The image processing apparatus 100 executes a program to perform a predetermined image processing on image data. The first operation unit 103 and the second operation unit 104 each include a processor and executes various operations.

The first memory 101 is a memory that stores the image data. Further, the first memory 101 may store the aforementioned program. The second memory 102 is a memory that can be accessed by the first operation unit 103 at a speed higher than that at which the first operation unit 103 accesses the first memory 101. The first operation unit 103 executes a task on the image data to perform the predetermined image processing. More specifically, the first operation unit 103 executes a predetermined task on a predetermined area of the image data transferred from the first memory 101 to the second memory 102 to perform the predetermined image processing. That is, the first operation unit 103 performs the predetermined image processing using the image data of coordinates to be processed transferred to the second memory 102 and the image data in a predetermined range that needs to be accessed to process the coordinates transferred to the second memory 102. While the predetermined image processing includes filter processing that involves convolution, the predetermined image processing is not limited thereto. In this way, the first operation unit 103 executes the predetermined task on the predetermined area of the image data transferred from the first memory 101 to the second memory 102. The first operation unit 103 sequentially performs the predetermined image processing on the plurality of coordinates of the image data. That is, the first operation unit 103 sequentially executes the task for each of the coordinates to be processed.

The second operation unit 104 executes the following processing before the execution of the task by the first operation unit 103. The second operation unit 104 and the first operation unit 103 may be formed as one operation unit. The processing unit may serve, for example, as the first operation unit 103 and the second operation unit 104. First, the second operation unit 104 determines whether there is an overlapping part of a first area of the image data executed corresponding to a first task executed by the first operation unit 103 and a second area of the image data executed corresponding to a second task different from the first task. In other words, the second operation unit 104 determines whether there is an overlapping part of the first area of the image data accessed when the first task is executed and the second area of the image data accessed when the second task is executed. The first area includes coordinates to be processed by the first task and the second area includes coordinates to be processed by the second task.

The memory control apparatus 105 is a control circuit such as a memory controller and controls the first memory 101 and the second memory 102. When it is determined in the aforementioned determination by the second operation unit 104 that there is an overlapping part, the memory control apparatus 105 performs control to reuse the image data in the second memory. When it is determined that there is an overlapping part, the memory control apparatus 105 performs, for example, control different from the control performed when it is determined that there is no overlapping part.

As described above, the image processing apparatus 100 is able to determine whether there is an overlapping part of the access areas of the image data between tasks and to specify whether the image data can be reused. When it is determined that the image data can be reused, control different from the control performed when the reuse cannot be performed may be performed so that the image data can be reused. Accordingly, it is possible to reuse the image data that can be reused on the second memory 102 more definitely, whereby it is possible to improve the processing speed of the image data.

### First Embodiment

Hereinafter, with reference to the drawings, a first embodiment will be described. FIG. 2 is a block diagram showing a configuration of an image processing system 1 according to this embodiment. As shown in FIG. 2, the image processing system 1 according to this embodiment includes an image processing apparatus 10 and a compile apparatus 20.

The image processing apparatus 10 executes a predetermined image processing in accordance with a program (object code) provided from the compile apparatus 20. As will be described later, when the image processing apparatus 10 is executing the image processing, it executes a prefetch instruction according to the program provided from the compile apparatus 20. The compile apparatus 20, which includes a function as a computer, executes a compiler and converts a source code that has been input into an object code. In this embodiment, the compile apparatus 20 adds instructions to control the prefetch to the object code when compiling programs that instruct the predetermined image processing. Specific processing of the compile apparatus 20 will be described later.

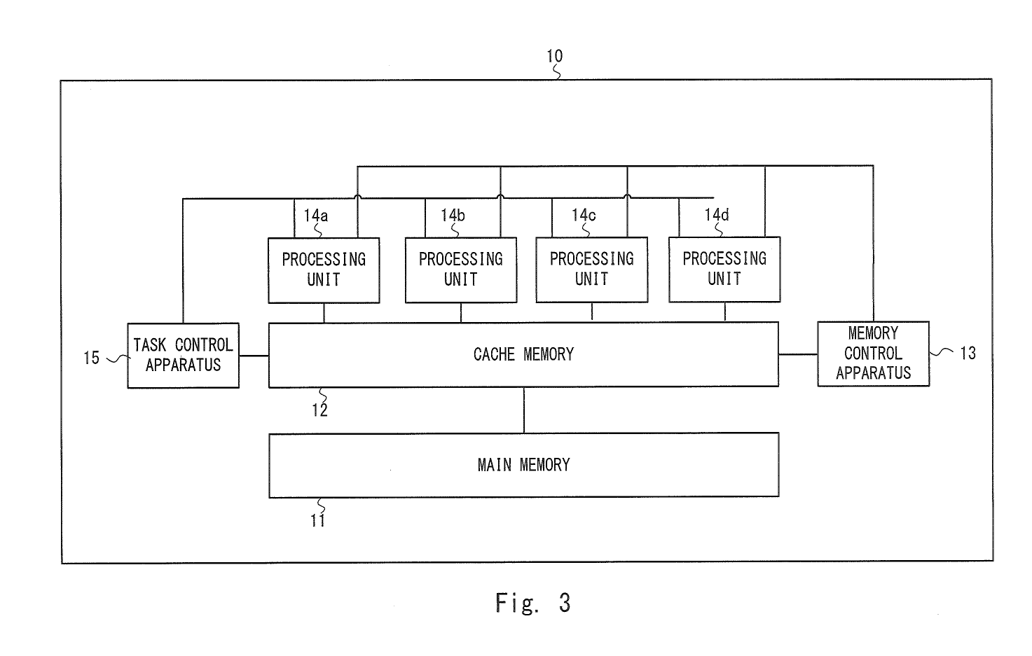

The image processing apparatus 10 includes, as shown in FIG. 3, a main memory 11, a cache memory 12, a memory control apparatus 13, processing units 14a, 14b, 14c, and 14d, and a task control apparatus 15. In the following description, the processing units 14a, 14b, 14c, and 14d may be collectively referred to as a processing unit 14. While parallel processing can be performed by the four processing units 14 in the image processing apparatus 10 in the example shown in FIG. 3, the number of processing units 14 is not limited to four. That is, the number of processing units 14 may be one or may be two, three, or five or more.

The main memory 11 corresponds to the aforementioned first memory 101 and stores the image data. Further, the main memory 11 stores the object code compiled by the compile apparatus 20. The object code may be stored in a memory other than the main memory 11. The cache memory 12 corresponds to the aforementioned second memory 102 and can be accessed by the processing unit 14 at a speed higher than that at which the processing unit 14 accesses the main memory 11. The memory control apparatus 13 corresponds to the aforementioned memory control apparatus 105 and controls reading and writing of data in the cache memory 12 and the main memory 11. The memory control apparatus 13 transfers the data from the main memory 11 to the cache memory 12 according to an instruction from the processing unit 14. That is, when the processing unit 14 executes the prefetch instruction, a prefetch operation according to the prefetch instruction is performed.

The processing unit 14 corresponds to the first operation unit 103 and the second operation unit 104 stated above and executes tasks assigned from the task control apparatus 15. As described above, in this embodiment, the plurality of processing units 14 process tasks in parallel. The processing units 14 are each able to access the cache memory 12 and each execute the task on the image data prefetched from the main memory 11 to the cache memory 12 to perform the predetermined image processing. Further, when the processing unit 14 is executing the task, it executes the prefetch instruction to instruct the memory control apparatus 13 to transfer the data accessed by the task from the main memory 11 to the cache memory 12. The execution of the prefetch instruction is performed according to the aforementioned program (object code).

There are two types of prefetch instructions executed by the processing unit 14. That is, the prefetch instructions executed by the processing unit 14 include a first prefetch instruction to allow the processing unit 14 to access data a plurality of times (hereinafter the first prefetch instruction will be called a prefetch instruction for a multiple use) and a second prefetch instruction to allow the processing unit 14 to access data only once (hereinafter the second prefetch instruction will be called a prefetch instruction for a single use). The prefetch instruction for the multiple use is an instruction in which eviction of the data from the cache memory 12 is performed, for example, by an LRU algorithm. Further, the prefetch instruction for the single use is an instruction in which the memory control apparatus 13 performs control to preferentially evict prefetched data after the prefetched data is once accessed by the processing unit 14. When data is fetched by the prefetch instruction for the single use and the prefetch instruction for the multiple use, fetch information indicating by which prefetch instruction the data has been fetched is supplied to each piece of data. The fetch information is stored, for example, in the memory control apparatus 13. The fetch information may be held in a cache or another storage means. The memory control apparatus 13 determines whether to preferentially evict the data or to hold the data for a long time based on the fetch information and evicts the data from the cache. Accordingly, a time during which the prefetched image data is held in the cache memory 12 in the first prefetch performed by the execution of the prefetch instruction for the multiple use is longer than a time during which the prefetched image data is held in the cache memory 12 in the second prefetch performed by the execution of the prefetch instruction for the single use. In other words, the time during which the prefetched image data is held in the cache memory 12 in the second prefetch performed by the execution of the prefetch instruction for the single use is shorter than the time during which the prefetched image data is held in the cache memory 12 in the first prefetch performed by the execution of the prefetch instruction for the multiple use.

The processing unit 14 determines whether there is an overlapping part of the first area of the image data executed corresponding to the first task and the second area of the image data executed corresponding to the second task that is executed later than the execution of the first task and executes one of the two types of prefetch instructions according to a result of the determination. In other words, the processing unit 14 determines whether there is an overlapping part of the first area of the image data accessed when the first task to be executed is executed and the second area of the image data accessed when the second task to be executed later than the execution of the first task is executed and executes the prefetch instruction according to the result of the determination.

Specifically, when it is determined that the first area and the second area overlap each other, the processing unit 14 executes the prefetch instruction for the multiple use to transfer the image data of the first area from the main memory 11 to the cache memory 12. Further, when it is determined that the first area and the second area do not overlap each other, the processing unit 14 executes the prefetch instruction for the single use to transfer the image data of the first area from the main memory 11 to the cache memory 12.

The memory control apparatus 13 performs the aforementioned first prefetch when it is determined that there is an overlapping part in the two areas, that is, when the processing unit 14 executes the prefetch instruction for the multiple use. Further, the memory control apparatus 13 performs the aforementioned second prefetch when it is determined that there is no overlapping part in the two areas, that is, when the processing unit 14 executes the prefetch instruction for the single use.

The task control apparatus 15 includes a queue formed of a memory or the like (not shown) and stores the tasks in the queue. The task control apparatus 15 sequentially sends the tasks stored in the queue to the processing unit 14. The tasks held by the task control apparatus 15 are supplied, for example, from a task division unit (not shown). The task division unit divides the predetermined image processing into a plurality of tasks based on the object code compiled by the compile apparatus 20 and the image data stored in the main memory 11. Accordingly, the plurality of tasks that define the image processing in the unit of a partial image are generated. The tasks held by the task control apparatus 15 include information indicating which data in which position (coordinate) on the image data this task uses.

Further, the task control apparatus 15 may assign the task stored in the task queue to each of the plurality of processing units 14 according to an assignment rule of the task selected in accordance with an instruction from the user among predetermined assignment rules.

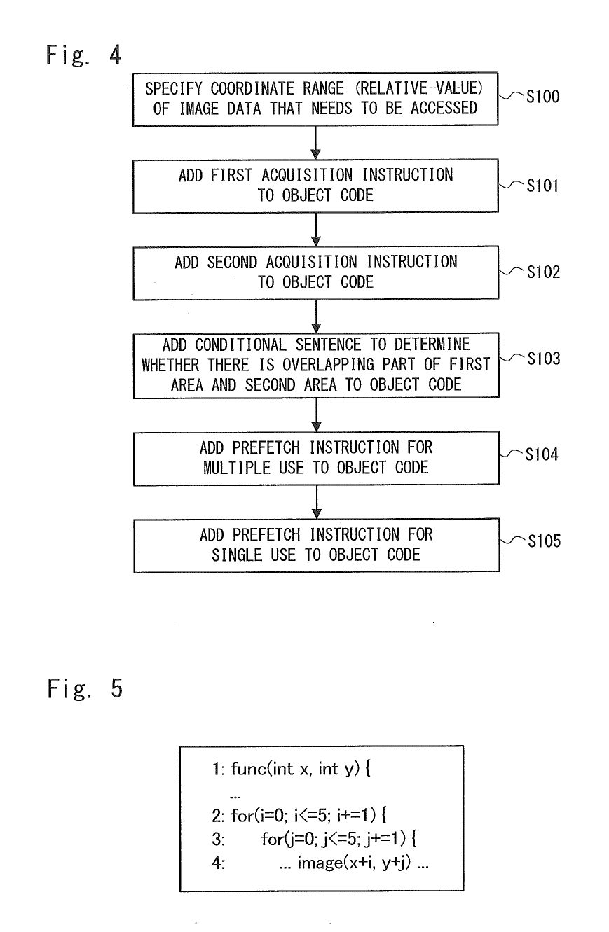

The instructions to control the prefetch are added to the object code executed by the image processing apparatus 10. In the following description, addition of the instructions in the compile apparatus 20 will be described. FIG. 4 is a flowchart showing one example of processing for adding the instructions performed in the compile processing in the compile apparatus 20. In the following description, with reference to FIG. 4, the processing for adding the instructions performed in the compile processing will be described.

In Step 100 (S100), the compile apparatus 20 analyzes the program and specifies the coordinate range of the image data that needs to be accessed in order to process the coordinates to be processed. In Step 100, the coordinate range is specified as a relative value from the coordinates to be processed. In Step 100, the coordinate range may not necessarily be specified. When, for example, the range is specified by a constant in the source code, the coordinate range can be specified. On the other hand, when the range is specified by a variable, the range is not determined until the time the image processing apparatus 10 executes processing.

The compile apparatus 20 may specify the coordinate range that needs to be accessed by analyzing, for example, the range in which the loop of the source code is iterated when the programs are compiled. Alternatively, the compile apparatus 20 may analyze the access destination from the memory access instruction of the object code and specify the coordinate range that needs to be accessed.

The compile apparatus 20 analyzes, for example, the source code shown in FIG. 5 and specifies the coordinate range of the image data that needs to be accessed in order to process the coordinates to be processed. In the program example shown in FIG. 5, the function “func” receives the XY coordinates as parameters and accesses the image data “image”. The image processing apparatus 10 changes the XY coordinate values and operate this function in parallel. When a compiler includes a typical optimization function, it can be determined that the access area is (x:x+5, y:y+5) from the source code shown in FIG. 5. That is, when (x, y) coordinates are to be processed, it is specified that the range of (0:5, 0:5) from the (x, y) coordinates is the access area.

In Step 101 (S101), the compile apparatus 20 adds a first acquisition instruction to acquire the coordinate information for the first task to the object code.

In Step 102 (S102), the compile apparatus 20 adds a second acquisition instruction to acquire the coordinate information for the second task to be executed in the processing unit 14 later than the execution of the first task to the object code.

In Step 103 (S103), the compile apparatus 20 adds an instruction (conditional sentence) to determine whether there is an overlapping part of the first area specified as a result of the execution of the first acquisition instruction added in Step 101 by the processing unit 14 and the second area specified as a result of the execution of the second acquisition instruction added in Step 102 by the processing unit 14 to the object code. The first area is an area of the image data accessed when the first task is executed and the second area is an area of the image data accessed when the second task is executed. That is, the first area is an area of the image data executed corresponding to the first task and the second area is an area of the image data executed corresponding to the second task different from the first task.

In Step 104 (S104) and Step 105 (S105), the compile apparatus 20 adds the prefetch instruction to the object code. More specifically, in Step 104, the compile apparatus 20 adds the instructions to execute the prefetch instruction for the multiple use when it is determined that the first area and the second area overlap each other. That is, the compile apparatus 20 adds the instructions to execute the prefetch instruction for the multiple use when the conditional sentence added in Step 103 is established (that is, when it is determined that there is an overlapping part).

Further, in Step 105, the compile apparatus 20 adds instructions to execute the prefetch instruction for the single use when it is determined that the first area and the second area do not overlap each other. That is, the compile apparatus 20 adds the instructions to execute the prefetch instruction for the single use when the conditional sentence added in Step 103 is not established (that is, when it is determined that there is no overlapping part).

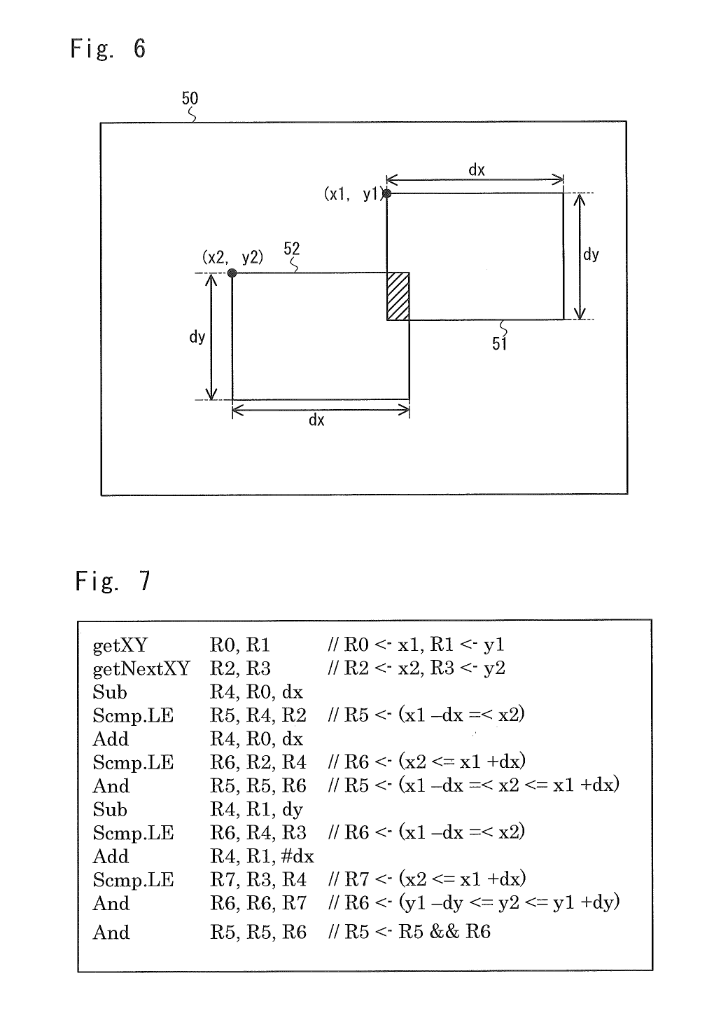

With reference to some specific examples, an operation of the aforementioned compile apparatus 20 will be described. FIG. 6 is a schematic view showing one example of the first area of the first task and the second area of the second task. The example shown in FIG. 6 shows a first area 51 of an image data 50 accessed when the first task is executed and a second area 52 of the image data 50 accessed when the second task is executed. In the example shown in FIG. 6, the coordinates to be processed by the first task are (x1, y1) and the coordinates to be processed by the second task are (x2, y2). Further, in FIG. 6, the overlapping area of the first area 51 and the second area 52 is hatched. The width of the first area 51 and the second area 52 in the x direction is dx and the width of the first area 51 and the second area 52 in the y direction is dy. When it is assumed that the task shown in FIG. 6 is based on the program shown in FIG. 5, it is specified in Step 100 that both dx and dy are 5.

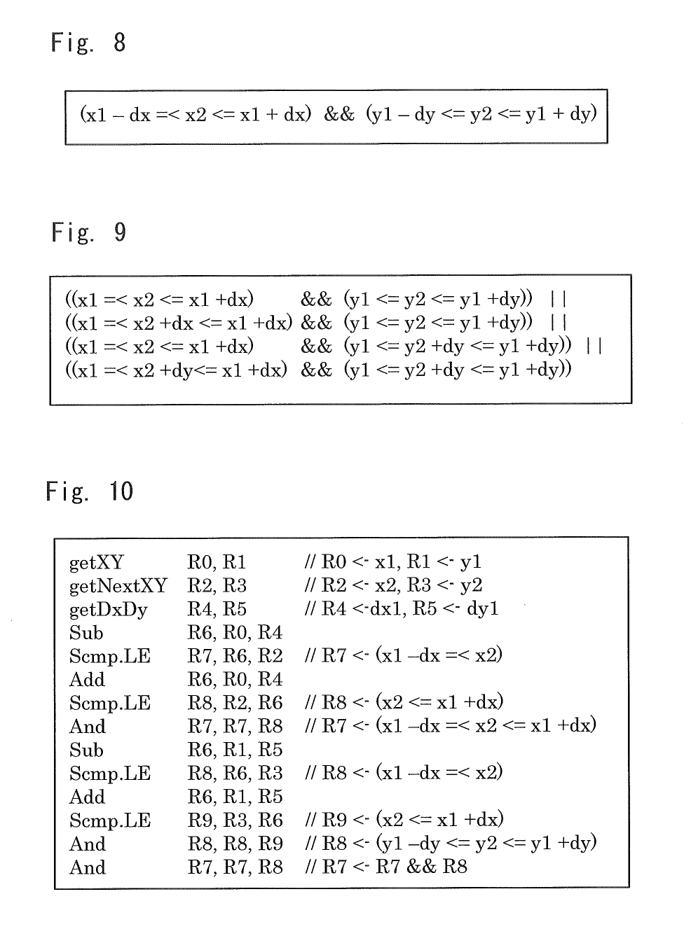

FIG. 7 is an example of the instructions added to the object code in Steps 101 to 103 shown in FIG. 4. The program shown in FIG. 7 is an example of the program when the coordinate range of the image data that needs to be accessed to process the coordinates to be processed is specified as a relative value from the coordinates to be processed in the aforementioned Step 100. In FIG. 7, the function getXY in the first line corresponds to the first acquisition instruction added in the aforementioned Step 101 and the function getNextXY in the second line corresponds to the second acquisition instruction added in the aforementioned Step 102. Further, the instructions in the third and subsequent lines correspond to the instructions added in Step 103 that determines whether there is an overlapping part. In the instructions in the third and subsequent lines, the determination sentence shown in FIG. 8 is expressed in the form of a program. Further, the determination sentence shown in FIG. 8 is equal to the determination sentence shown in FIG. 9 and determines whether there is an overlapping part of the first area 51 and the second area 52.

In FIG. 7, the instructions shown after the double slash are comments on the program. In the example shown in FIG. 7, the coordinates to be processed by the first task are substituted into variables R0 and R1 and the coordinates to be processed by the second task are substituted into variables R2 and R3. The result regarding whether there is an overlapping part between the first area 51 and the second area 52 is stored in a variable R5.

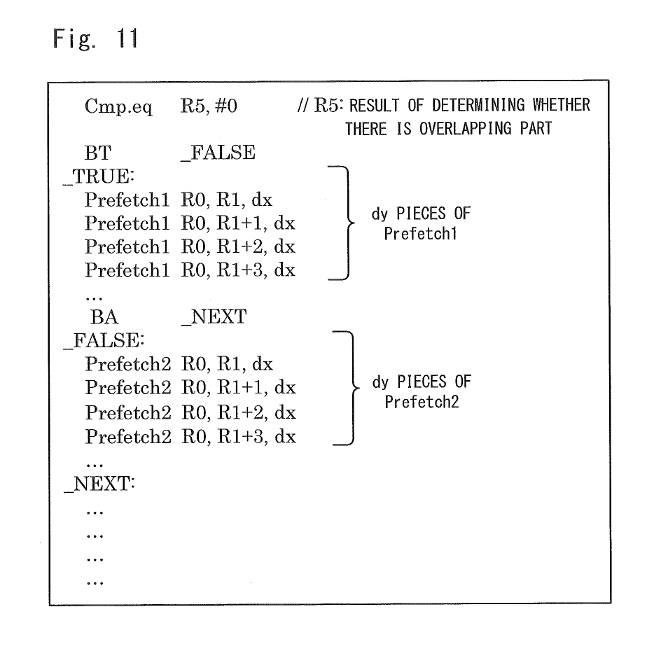

When the coordinate range of the image data that needs to be accessed to process the coordinates to be processed is not specified in the aforementioned Step 100, the instruction to acquire the coordinate range (getDxDy) is further added in the compile apparatus 20 as shown in, for example, FIG. 10. In FIG. 10, the function getXY and the function getDxDy correspond to the first acquisition instruction added in the aforementioned Step 101 and the function getNextXY and the function getDxDy correspond to the second acquisition instruction added in the aforementioned Step 102. In the example shown in FIG. 10, the result regarding whether there is an overlapping part of the first area 51 and the second area 52 is stored in a variable R7.

The image processing apparatus 10 may be formed so that the processing shown in the instruction sequences shown in FIG. 7 or 10 can be performed by one instruction (e.g., an instruction “checkrange” to receive dx and dy and determine whether there is an overlapping part). That is, the processing unit 14 may execute the processing for determining whether there is an overlapping part of the first area 51 and the second area 52 by executing one instruction. This is achieved by providing a dedicated circuit that processes this instruction.

It may therefore be possible to reduce the program size and to improve the speed of the processing for determining the overlapping part of the access areas. Further, since the number of registers to be used can be reduced, a reduction in the performance by spilling can be reduced.

FIG. 11 is an example of instructions added to the object code in Steps 104 and 105 shown in FIG. 4. When the program shown in FIG. 11 is executed, the value of a variable R5 is determined. That is, it is determined whether there is an overlapping part. When the program shown in FIG. 10 is generated by the compile apparatus 20 in place of the program shown in FIG. 7, the value of a variable R7 is determined. When there is an overlapping part, an instruction Prefetch 1, which is the prefetch instruction for the multiple use, is executed by the processing unit 14 and when there is no overlapping part, an instruction Prefetch 2, which is the prefetch instruction for the single use, is executed by the processing unit 14. In the example shown in FIG. 11, when there is an overlapping part, the instruction Prefetch 1 is repeatedly executed for each line. Further, when there is no overlapping part, the instruction Prefetch 2 is repeatedly executed for each line. Accordingly, the image data in the predetermined area is prefetched to the cache memory 12. In the program shown in FIG. 11, the program that defines the image processing content is described after the last “_NEXT:”.

The image processing apparatus 10 may be formed so that the prefetch instruction repeated a plurality of times shown in FIG. 11 can be performed by one instruction (e.g., an instruction “Prefetch1range” or “Prefetch2range” to receive the coordinates to be processed, dx, and dy and to prefetch the image data in the range to be prefetched). That is, the prefetch instruction executed when it is determined that there is an overlapping part may be an instruction to prefetch the image data in the range to be prefetched by one instruction. Further, the prefetch instruction executed when it is determined that there is no overlapping part may be an instruction to prefetch the image data in the range to be prefetched by one instruction. This is achieved by providing a dedicated circuit that processes this instruction. It is therefore possible to reduce the program size and to reduce the time during which the program is executed. The aforementioned processing of performing prefetch by one instruction may be performed in combination with the aforementioned processing of performing determination by one instruction.

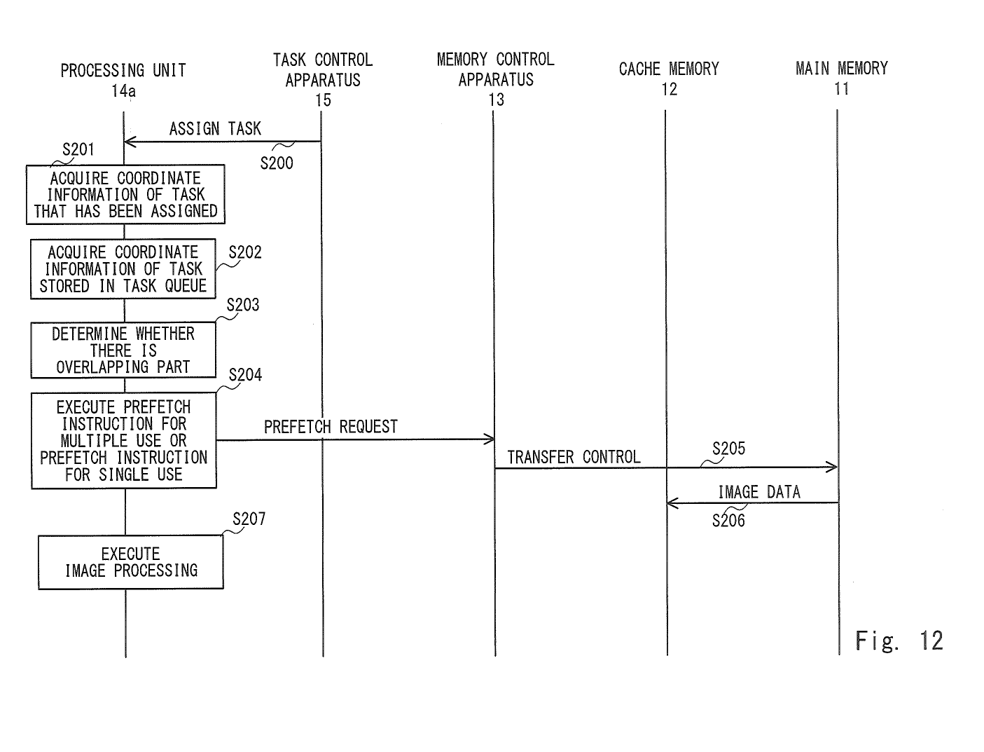

The image processing apparatus 10 executes the object code thus generated by the compile apparatus 20. In the following description, an operation of the image processing apparatus 10 will be described. FIG. 12 is a sequence chart showing one example of the operation of the image processing apparatus 10. While the operation of the image processing apparatus 10 for the processing in the processing unit 14a will be mainly described in the sequence chart shown in FIG. 12, the image processing apparatus 10 operates in a similar way for the other processing units 14.

In Step 200 (S200), the task control apparatus 15 assigns the task to the processing unit 14a.

In Step 201 (S201), the processing unit 14a executes the first acquisition instruction stated above and acquires the coordinate information of the task assigned to the processing unit 14a in Step 200.

In Step 202 (S202), the processing unit 14a executes the aforementioned second acquisition instruction and acquires the coordinate information of the task stored in the queue of the task control apparatus 15, that is, the task waiting to be executed.

In Step 203 (S203), the processing unit 14a determines whether there is an overlapping part of the access area by the task to be currently processed assigned in Step 200 and the access area by the task waiting to be executed based on the coordinate information acquired in Steps 201 and 202.

When it is determined in Step 204 (S204) that there is an overlapping part, the processing unit 14a executes the prefetch instruction for the multiple use and when it is determined in Step 204 that there is no overlapping part, the processing unit 14a executes the prefetch instruction for the single use. Accordingly, a prefetch request of the image data used in the task assigned in Step 200 is sent to the memory control apparatus 13. According to the program shown in FIG. 11, when it is determined that there is an overlapping part, all the access areas by the task to be executed are prefetched by the prefetch instruction for the multiple use. Alternatively, only the overlapping part may be prefetched by the prefetch instruction for the multiple use and the non-overlapping part may be prefetched by the prefetch instruction for the single use.

In Step 205 (S205), the memory control apparatus 13 performs control to transfer the image data in accordance with the prefetch instruction sent in Step 204. That is, when the prefetch instruction executed by the processing unit 14a is the prefetch instruction for the multiple use, the image data to be transferred is managed, for example, as data to be evicted from the cache memory 12 by the LRU algorithm. On the other hand, when the prefetch instruction executed by the processing unit 14a is the prefetch instruction for the single use, the image data to be transferred is managed as the data to be preferentially evicted.

In Step 206 (S206), in accordance with the control of the memory control apparatus 13, the image data is transferred from the main memory 11 to the cache memory 12 and the prefetch is completed. That is, the image data in the area accessed when the task assigned in Step 200 is executed is prefetched.

In Step 207 (S207), the processing unit 14a executes the predetermined image processing in accordance with the task.

According to this embodiment, the processing unit 14 of the image processing apparatus 10 determines whether there is an overlapping part of the access area of the task to be executed and the access area of the subsequent task waiting to be executed and uses one of the two types of prefetch instructions depending on the result of the determination. It is therefore possible to check reusability of the data between the task which is being executed and the task that has not yet been executed and to reduce cases in which the data to be reused is once evicted from the cache memory 12 and then this data is transferred to the cache memory 12 again. Accordingly, the cache hit rate increases and the speed of image processing is increased.

That is, in the image processing apparatus 10, when the image data accessed by the task to be currently processed and the image data accessed by the subsequent task overlap each other, the image data accessed by the task to be currently processed is transferred from the main memory 11 to the cache memory 12 by the prefetch instruction for the multiple use. Further, when the image data accessed by the task to be currently processed and the image data accessed by the subsequent task do not overlap each other, the image data accessed by the task to be currently processed is transferred from the main memory 11 to the cache memory 12 by the prefetch instruction for the single use. It is therefore possible to prevent the prefetched image data accessed by the subsequent task from being evicted from the cache memory 12 before the image data is accessed by the subsequent task. It is therefore possible to suppress the reduction in the processing speed, which is due to the repeated prefetch of the data to be used in the subsequent task.

The above point will be further described in detail with some specific examples. As one example, a case in which a task A uses data α, a task B uses data β, a task C uses data γ, and a task D uses data a is assumed. That is, the task A and the task D use the same data α. The tasks A, B, C, and D are processed in this order. Further, for the sake of simplifying the explanation, it is assumed that only two pieces of data can be stored in the cache memory 12.

First, an example in which the aforementioned operation is not performed (comparative example) will be described. In the image processing apparatus according to the comparative example, when the task A is processed and then the process of the task B is ended, the data α and the data β are stored in the cache memory 12. In order to process the task C, the data stored in the cache memory 12 needs to be evicted. Typically, the data that has not been used for the longest time is evicted from the cache memory 12 according to a Least Recently Used (LRU) algorithm. Thus the longest not used data α is evicted. Since the task D uses the data α in the following processing, the data α needs to be transferred to the cache memory 12 again. Accordingly, in the image processing apparatus according to such a comparative example, the performance is reduced due to the transfer time.

Meanwhile, the image processing apparatus 10 operates as follows. First, since the data α used in the task A is also used in the later task D, when the task A is executed, the processing unit 14 executes the prefetch instruction for the multiple use for the data α. Next, when the task B is executed, the processing unit 14 executes the prefetch instruction for the single use for the data β since the data used by the task B is not used in the following tasks. Next, when the task C is executed, the processing unit 14 executes the prefetch instruction for the single use for the data γ since the data used by the task C is not used in the following tasks. Accordingly, the data β stored in the cache memory 12 is rewritten into the data γ. That is, the data α on the cache memory 12 is continuously stored in the cache memory 12. Thus, when the task D is executed, the data α has already been stored in the cache memory 12. Therefore, there is no need to transfer the data from the main memory 11. As stated above, in the image processing apparatus 10, the reduction in the processing speed can be suppressed.

### Second Embodiment

Next, a second embodiment will be described. FIG. 13 is a block diagram showing one example of a configuration of an image processing apparatus 30 according to the second embodiment. As shown in FIG. 13, the image processing apparatus 30 is different from the image processing apparatus 10 according to the first embodiment in that the cache memory 12 is replaced by a local memory 16. That is, while the cache memory 12 is used as the memory corresponding to the second memory 102 in the first embodiment, the local memory 16 is used in this embodiment. The local memory 16 is a memory formed of, for example, a Static Random Access Memory (SRAM) or the like dedicated for image processing and is a memory accessed by the processing unit 14 at a speed higher than that at which the processing unit 14 accesses the main memory 11. The image processing apparatus 30 executes the predetermined image processing using the image data transferred from the main memory 11 to the local memory 16.

Further, while the processing unit 14 corresponds to the aforementioned first operation unit 103 and the second operation unit 104 in the first embodiment, the processing unit 14 corresponds to the first operation unit 103 and the task control apparatus 15 corresponds to the second operation unit 104 in this embodiment.

While the data has been reused by the prefetch to the cache memory 12 in the first embodiment, the data is reused as described below instead of performing the prefetch in this embodiment.

In this embodiment, similar to the processing unit 14 of the first embodiment, the task control apparatus 15 determines whether the first area of the image data executed corresponding to the first task and the second area of the image data executed corresponding to the second task different from the first task overlap each other. In other words, in this embodiment, the task control apparatus 15 determines whether the first area of the image data accessed when the first task to be executed is executed and the second area of the image data accessed when the second task is executed overlap each other. However, the determination target is different from that in the first embodiment as follows. That is, while the second task, which is the determination target, is the task waiting to be executed in the first embodiment, the second task, which is the determination target, is the task that has already been executed in the processing unit 14 in this embodiment.

The task control apparatus 15 manages, besides the coordinate information on the task stored in the task queue, coordinate information on the task that has already been executed by the processing unit 14, on the task queue.

Then, the memory control apparatus 13 according to this embodiment performs control to reuse the image data stored in the local memory 16 for the area in the first area that has been determined to overlap the second area. Further, the memory control apparatus 13 according to this embodiment transfers the image data for the area in the first area that has been determined not to overlap the second area from the main memory 11 to the local memory 16.

That is, the image processing apparatus 30 according to this embodiment performs control to reuse the image data on the local memory 16 accessed by the task that has already been executed. In general, it takes time to transfer data from the main memory 11 to the local memory 16. Accordingly, the time required for the processing unit 14 to access necessary data by performing control to reuse existing data in the local memory 16 is shorter than the time required for the processing unit 14 to access necessary data by transferring data from the main memory 11 to the local memory 16 to execute the task. The image processing apparatus 30 according to this embodiment reuses the image data stored in the local memory 16 for an area that has been determined to overlap another area, whereby it is possible to reduce the processing time compared to the case in which the data is not reused.

When the processing unit 14 accesses the cache memory 12, the processing unit 14 can access the cache memory 12 using the address of the main memory 11. On the other hand, when the processing unit 14 accesses the local memory 16, since the local memory 16 includes an address space different from that of the main memory 11, a method of accessing the local memory 16 from the processing unit 14 needs to be devised. That is, the memory control apparatus 13 specifically performs the following control to reuse the image data on the local memory 16 accessed by the task that has already been executed when the task to be currently executed is executed.

The memory control apparatus 13 according to this embodiment corrects, when the first task is executed by the processing unit 14, for example, a storage position on the address space in the local memory 16 of the image data for the first area that has been determined to overlap the second area to a position in which a positional relation of the overlapping area and an area of the first area other than the overlapping area is maintained.

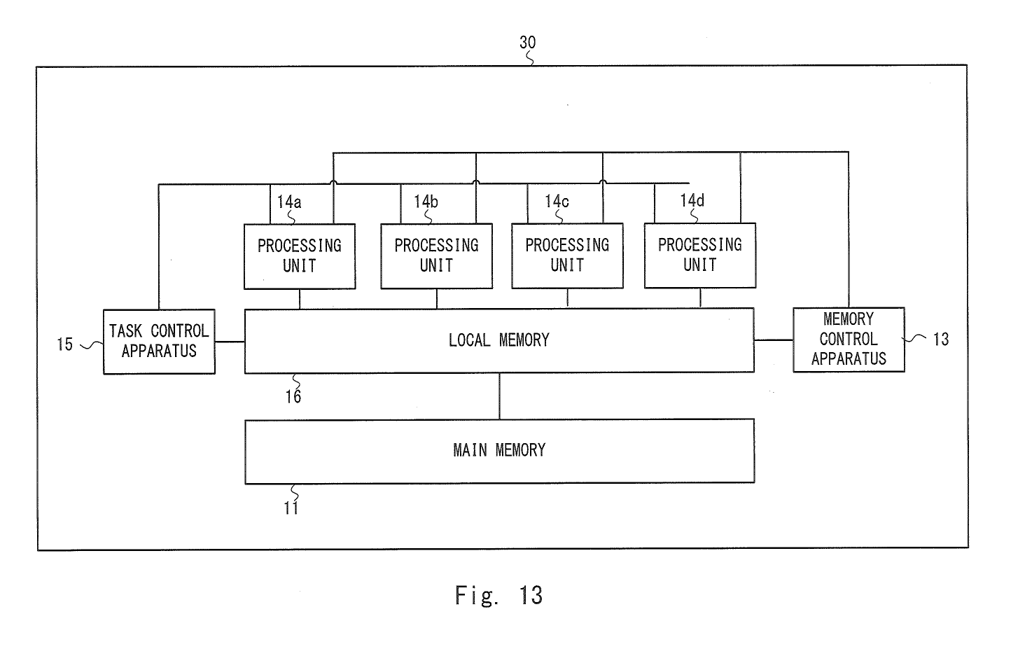

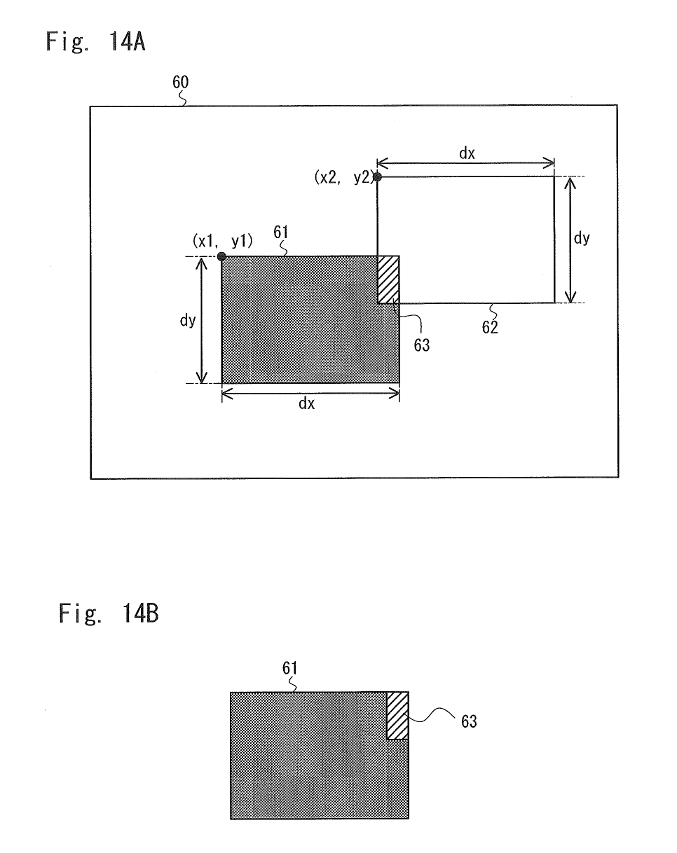

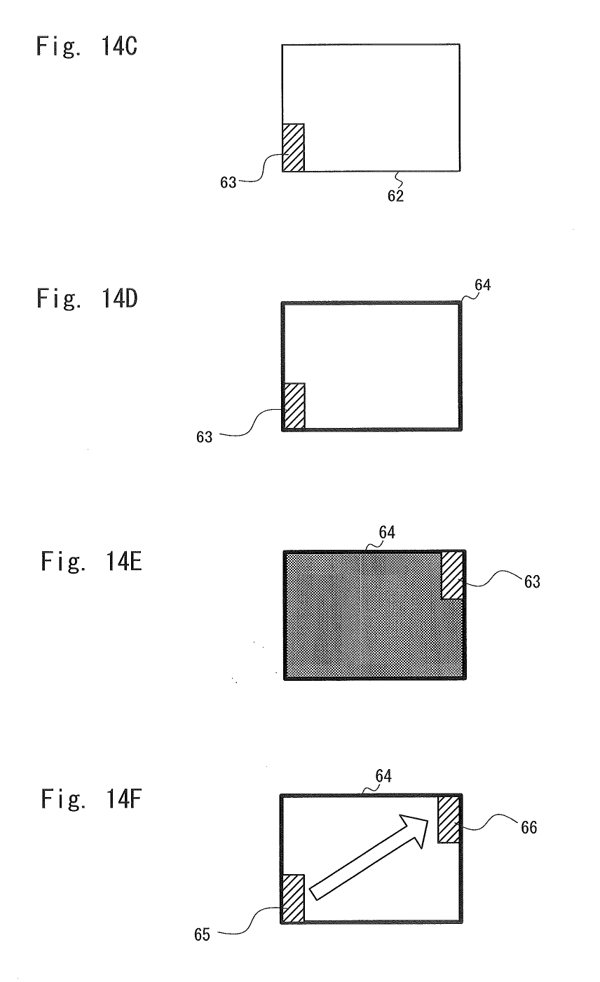

The above point will be described with reference to the drawings. FIG. 14A is a schematic view showing one example of the first area of the first task and the second area of the second task. The example shown in FIG. 14A shows a first area 61 of an image data 60 accessed when the first task is executed and a second area 62 of the image data 60 accessed when the second task is executed. In the example shown in FIG. 14A, the coordinates to be processed by the first task are (x1,y1) and the coordinates to be processed by the second task are (x2,y2). Further, in FIG. 14A, the overlapping area 63 of the first area 61 and the second area 62 is hatched. The width of the first area 61 and the second area 62 in the x direction is dx and the width of the first area 61 and the second area 62 in the y direction is dy. In this example, a case in which the image processing apparatus 30 executes the first task for the first area 61 after executing the second task for the second area 62 will be described. That is, since the first task is executed after the execution of the second task in this example, after the second area 62 is arranged on the local memory 16, the first area 61 is arranged on the local memory 16.

FIG. 14B is a diagram showing a relative position of the overlapping area 63 in the first area 61. Further, FIG. 14C is a diagram showing a relative position of the overlapping area 63 in the second area 62. Since the overlapping area 63 is an overlapping part of the two areas, the value of the overlapping area 63 in the first area 61 is the same as the value of the overlapping area 63 in the second area 62. However, as shown in FIGS. 14B and 14C, the relative position of the overlapping area 63 in the first area 61 is different from the relative position of the overlapping area 63 in the second area 62.

FIG. 14D is a schematic view showing one example of a state of an address space 64 of the local memory 16 just after the second task has been executed. As shown in FIG. 14D, on the address space 64 of the local memory 16 just after the second task is executed, the area to be reused, which is the overlapping area 63 of the first area 61 and the second area 62, is located at the lower left. Accordingly, the memory control apparatus 13 copies the area to be reused in the local memory 16 to correct the storage position on the address space in the local memory 16 of the image data for the area to be reused to a position in which a positional relation between the area to be reused and another area in the first area 61 is maintained. FIG. 14E is a schematic view showing one example of a state of an address space 64 of the local memory 16 after the storage position on the address space is corrected. As shown in FIG. 14E, the storage position of the area to be reused (overlapping area 63) is corrected so that it moves to the upper right. In FIG. 14E, the blackened area shows the image data of the first area 61 other than the overlapping area 63. The memory control apparatus 13 transfers the first area 61 other than the overlapping area 63 from the main memory 11 to the local memory 16 as shown in FIG. 14E. To sum up, as shown in FIG. 14F, the overlapping area 63 is copied from a storage position 65 after execution of the second task to a storage position 66 before execution of the first task on the local memory 16.

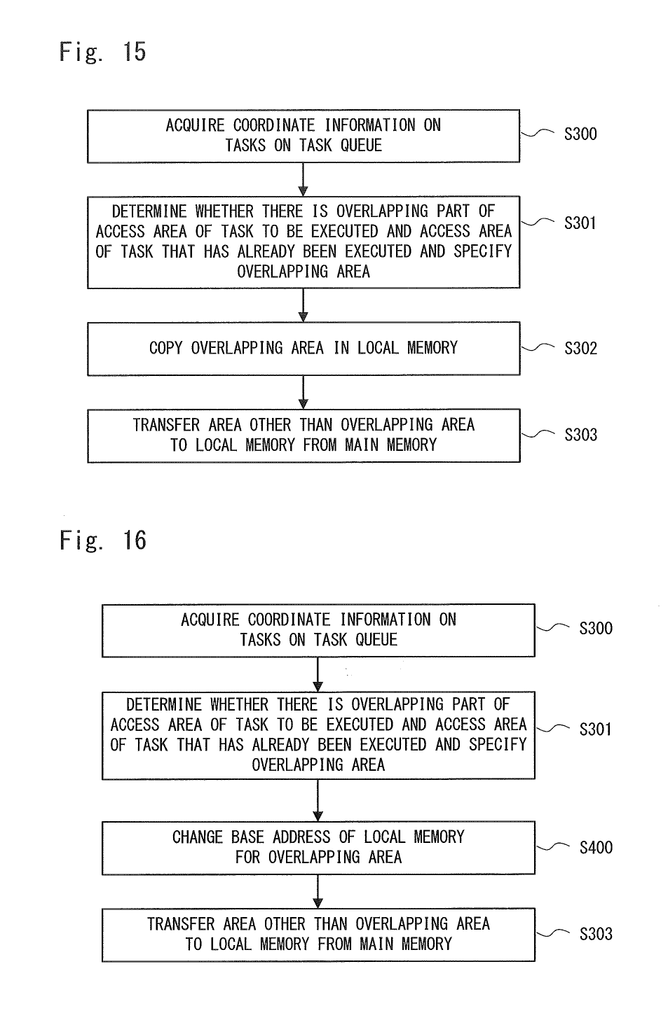

Next, an operation of the image processing apparatus 30 according to this embodiment will be described. FIG. 15 is a flowchart showing one example of the operation of the image processing apparatus 30. In the following description, with reference to FIG. 15, the operation thereof will be described.

In Step 300 (S300), the task control apparatus 15 acquires coordinate information on the tasks on the task queue. That is, the task control apparatus 15 acquires the coordinate information on the first task, which is the task to be executed, and the coordinate information on the second task, which is the task that has already been executed.

In Step 301 (S301), the task control apparatus 15 determines whether there is an overlapping part in the access areas specified from the coordinate information acquired in Step 300. That is, the task control apparatus 15 determines whether there is an overlapping part of the access area of the task to be executed (first task) and the access area of the task that has already been executed (second task) and specifies the overlapping area.

When the overlapping area is specified in Step 301, the task control apparatus 15 sends an instruction to the memory control apparatus 13 to copy the overlapping area in the local memory in Step 302 (S302). When it is determined in Step 301 that there is no overlapping part, the task control apparatus 15 does nothing in Step 302 (S302). The memory control apparatus 13 then executes the copy in the local memory 16.

In Step 303 (S303), for a range of the access area of the task to be executed (first task) that does not overlap the access area of the task (second task) that has already been executed, an instruction is sent to the memory control apparatus 13 to transfer the image data from the main memory 11 to the local memory 16. Accordingly, the memory control apparatus 13 transfers the image data from the main memory 11 to the local memory 16.

According to the above operation, the data that can be reused in the local memory 16 can be copied in the local memory 16, whereby it is possible to eliminate the amount of data transferred from the main memory 11 to the local memory 16. The processing time required for the data copy in the local memory 16 is shorter than the processing time required for the data transfer from the main memory 11 to the local memory 16. It is therefore possible to reduce the processing time required for the data transfer and to improve the whole processing speed.

Alternatively, another method for reusing the data may be used. That is, the memory control apparatus 13 may convert, when the first task is executed by the processing unit 14, a first address specified by the processing unit 14 when the processing unit 14 accesses the image data in the local memory 16 into a second address. The second address is an address indicating the actual storage position on the address space in the local memory 16 of the image data of a position of coordinates to be accessed by the processing unit 14. That is, the memory control apparatus 13 may allow the processing unit 14 to appropriately access the image data by converting the address specified by the processing unit 14 into another address instead of correcting the storage position as stated above. The memory control apparatus 13 changes, for example, abase address, which is a logical address of the local memory 16.

FIG. 16 is a flowchart showing one example of an operation of the image processing apparatus 30 when data on the local memory 16 is reused by changing addresses. In the flowchart shown in FIG. 16, Step 302 in the flowchart shown in FIG. 15 is replaced by Step 400.

In Step 400 (S400), the task control apparatus 15 sends an instruction to change the base address of the local memory 16 for the overlapping area to the memory control apparatus 13. In the processing in Step 400, instead of copying data in the local memory 16, the logical address with respect to a physical address of the local memory 16 is changed.

With reference to FIG. 14F, in Step 400, processing for changing the logical address of the head position of the storage position 65 on the address space 64 of the local memory 16 to the logical address of the head position of the storage position 66 is performed. In this processing, there is no change in the physical address. Therefore, there is no change in the data stored in the local memory 16 and the data can be treated as if it were transferred. Accordingly, in a way similar to the case in which the data is copied in the local memory 16, the processing unit 14 is able to appropriately access the image data in the access area by the first task.

When data is copied in the local memory 16, it takes time to copy the data. On the other hand, according to the method shown in FIG. 16, by changing addresses, it is possible to omit the processing of copying data and thus to improve the speed of the processing.

While the invention made by the present inventors has been specifically described based on the embodiments, it is needless to say that the present invention is not limited to the embodiments already stated above and various changes may be made on the embodiments without departing from the spirit of the present invention.

Further, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (Such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An image processing apparatus comprising:
a first memory that stores image data;
a second memory that can be accessed at a speed higher than that in an access to the first memory;
a first operation unit that executes a predetermined task on a predetermined area of the image data transferred from the first memory to the second memory;
a second operation unit that determines whether there is an overlapping part of a first area of the image data executed corresponding to a first task executed by the first operation unit and a second area of the image data executed corresponding to a second task different from the first task; and
a memory control apparatus that controls the first memory and the second memory,
wherein the memory control apparatus performs control to reuse the image data in the second memory when it is determined in the second operation unit that there is an overlapping part.

2. The image processing apparatus according to claim 1, wherein:
the second memory is a cache memory,
the second task is a task to be executed later than the first task,
the first operation unit executes a first prefetch instruction to transfer the image data of the first area from the first memory to the second memory when it is determined that the first area and the second area overlap each other and executes a second prefetch instruction to transfer the image data of the first area from the first memory to the second memory when it is determined that the first area and the second area do not overlap each other,
the memory control apparatus executes a first prefetch when the first prefetch instruction has been executed and executes a second prefetch when the second prefetch instruction has been executed, and
a period during which the image data that has been prefetched as a result of the first prefetch is held in the second memory is longer than a period during which the image data that has been prefetched as a result of the second prefetch is held in the second memory.

3. The image processing apparatus according to claim 2, wherein each of the first prefetch instruction and the second prefetch instruction is an instruction that prefetches the image data in a range to be prefetched by one instruction.

4. The image processing apparatus according to claim 1, wherein:
the second memory is a local memory,
the second task is a task that has already been executed, the second task being different from the first task, and
the memory control apparatus performs control to reuse the image data stored in the local memory for an area in the first area that has been determined to overlap the second area and transfers the image data for the area in the first area that has been determined not to overlap the second area from the first memory to the local memory.

5. The image processing apparatus according to claim 4, wherein the memory control apparatus corrects a storage position on an address space in the local memory of the image data for an overlapping area of the first area that has been determined to overlap the second area to a position in which a positional relation between the overlapping area and an area of the first area other than the overlapping area is maintained when the first task is executed by the first operation unit.

6. The image processing apparatus according to claim 4, wherein:
the memory control apparatus converts, when the first task is executed by the first operation unit, a first address specified by the first operation unit when the first operation unit accesses the image data in the local memory into a second address, and
the second address is an address indicating an actual storage position on the address space in the local memory of the image data in a position of coordinates to be accessed by the first operation unit.

7. The image processing apparatus according to claim 1, wherein the second operation unit performs processing for determining whether the first area and the second area overlap each other by executing one instruction.

8. An image processing method comprising the steps of:
determining whether a first area of image data executed corresponding to a first task and a second area of the image data executed corresponding to a second task that will be executed later than the first task overlap each other;
performing a first prefetch when it is determined that the first area and the second area overlap each other and performing a second prefetch when it is determined that the first area and the second area do not overlap each other; and
executing the first task using the image data prefetched to a cache memory,
wherein a period during which the image data that has been prefetched as a result of the first prefetch is held is longer than a period during which the image data that has been prefetched as a result of the second prefetch is held.

9. An image processing method comprising the steps of:
determining whether a first area of image data executed corresponding to a first task and a second area of the image data executed corresponding to a second task that has already been executed overlap each other, the second task and the first task being different from each other;
performing control to reuse the image data stored in a local memory for an area in the first area that has been determined to overlap the second area; and
transferring the image data for the area in the first area that has been determined not to overlap the second area to the local memory from a main memory.

10. The image processing method according to claim 9, wherein, in the controlling step, when the first task is executed, a storage position on an address space in the local memory of the image data for an overlapping area of the first area that has been determined to overlap the second area is corrected to a position in which a positional relation between the overlapping area and an area of the first area other than the overlapping area is maintained.

11. The image processing method according to claim 9, wherein:
in the controlling step, when the first task is executed, a first address specified at a time of access to the image data in the local memory is converted into a second address, and
the second address is an address indicating an actual storage position on the address space in the local memory of the image data in a position of coordinates to be accessed.
